(19) United States
(12) Patent Application Publication
(10) Pub. No.: US 2009/0003347 A1
(43) Pub. Date: Jan. 1, 2009

(54) Backhaul transmission efficiency

(76) Inventors: Tomas S. Yang, Parsippany, NJ (US); William Garrant Couch, Hillsborough, NJ (US); Michael John Lemke, Plainfield, IL (US); Yong H. Choo, Andover, NJ (US); Edward Fredrick Berliner, Randolph, NJ (US); Mohammed Riaz Khawer, Lake Hopatcong, NJ (US); Hector G. Torres, Aurora, IL (US)

Correspondence Address: HARNESS, DICKEY & PIERCE, P.L.C., P.O. BOX 8910, RESTON, VA, 20195, US

(21) Appl. No.: 11/819,767

(22) Filed: Jun. 29, 2007

(51) Int. Cl. H04L 12/56

(52) U.S. Cl. 370/392

(57) ABSTRACT

In one embodiment, the method includes determining, at a first network element, whether to turn on compression of a header for a packet transport protocol used for a communication flow between the first network element and a second network element. The determining is based on a type of the communication flow, and the packet transport protocol is a protocol for transport of packets between the first and second network elements. The method further includes sending a compression mode indictor to the second network element along with a context identifier. The compression mode indicator indicates the determination, and the context identifier for use in identifying the communication flow.

### BACKGROUND OF THE INVENTION

1. Field of the Invention

Example embodiments of the present invention relate generally to improving efficiency of transmission over a backhaul of a wireless communications network.

2. Description of the Related Art

FIG. 1 illustrates a general architecture of a well-known wireless communication network. In particular, FIG. 1 illustrates a portion of an EVDO wireless network. As shown, an access terminal (AT) 10 communicates with a base transceiver station (BTS) 12 over an air interface. Examples of an AT include a mobile station, a mobile unit, a wireless phone, wireless equipped PDA or computer, etc. Multiple base transceiver stations 12 communicate with a radio network controller (RNC) 14, which provides signaling and traffic processing for each wireless data session. The AT 10, BTS 12, RNC 14, and the interfaces between these components form what is known as a radio access network (RAN). The RAN communicates with a core network to access, for example, the internet. In the example of FIG. 1, the core network includes one or more packet data service nodes (PDSNs) 16 connected between the RNCs 14 and, for example, the internet (not shown).

The interface 18 between the BTS 12 and the RNC 14 is often called the backhaul. In particular, the interface 18 typically includes multiple T1/E1 lines connected between the BTS 12 and the RNC 14 for carrying packet data (e.g., IP packet data) between the BTS 12 and the RNC 14. Packet data flowing from the BTS 12 to the RNC 14 is said to flow over the reverse link, and packet data flowing from the RNC 14 to the BTS 12 is said to flow over the forward link. Typically, the transmission of packet data between the BTS 12 and the RNC 14 follows the well-known Remote Method Invocation (RMI) protocol. The RMI protocol is a hierarchal protocol placed on top of the UDP/IP packets being sent between the BTS 12 and the RNC 14. Namely, each protocol generally consists of a payload and associated header, and the previous protocol becomes nested inside the subsequent protocol as at least part of the payload for the subsequent protocol. The nested protocols are often referred to as a stack.

Backhaul packet transport efficiency is expressed as a ratio of the user payload to the sum of the user payload and the overhead (e.g., headers for payloads according to each protocol) for transporting this payload. For large data packets, the full RMI/UDP/IP protocol stack results in relatively high efficiency. However, overhead of the full stack is not negligible and the backhaul transport efficiency drops dramatically when smaller packets are sent.

For example, Voice over IP (VOIP) and Push to Talk (PTT) applications are expected to dramatically increase the volume of small packets on both the forward and reverse links. As discussed above, T1 carriers are used for backhaul transport. Inefficient transport would result in a large cost increase as more T1s are needed to handle the increase backhaul load.

### SUMMARY OF THE INVENTION

The present invention relates a method of managing header compression.

In one embodiment, the method includes determining, at a first network element, whether to turn on compression of a header for a packet transport protocol used for a communication flow between the first network element and a second network element. The determining is based on a type of the communication flow, and the packet transport protocol is a protocol for transport of packets between the first and second network elements. The method further includes sending a compression mode indictor to the second network element along with a context identifier. The compression mode indicator indicates the determination, and the context identifier for use in identifying the communication flow.

Another embodiment of the method includes receiving, from a first network element, at least a forward link compression mode indictor and a reverse link context identifier at a second network element. The forward link compression mode indicator indicates whether compression of a header for a packet transport protocol has been turned on for packets of a communication flow over a forward link. The packet transport protocol is a protocol for transport of packet between the first and second network elements. The reverse link is communication flowing from the second network element to the first network element. The reverse link context identifier is for use in identifying the communication flow on the reverse link. The forward link is communication flowing from the first network element to the second network element. The method further includes determining a forward link context identifier based on the forward link compression mode indicator, the forward link context identifier for use in identifying the communication flow on the forward link, and sending the forward link context identifier to the first network element.

The present invention further relates to a method of processing a packet data flow.

In one embodiment, the method includes determining whether compression of a header for a packet transport protocol between a first network element and a second network element has been turned on for a communication flow between the first network element and the second network element. A compressed header that includes a context identifier is generated if the determining step determines that compression has been turned on. The context identifier is for use in identifying the communication flow. Another embodiment includes receiving a packet according to a transport protocol for packet communication between a first network element and a second network element. Whether a header of the packet has been compressed is then determined. The header is decompressed based on a context identifier in the compressed header if the determining step determines the header has been compressed. The context identifier identifies a communication flow between the first network element and the second network element.

### BRIEF DESCRIPTION OF THE DRAWINGS

The present invention will become more fully understood from the detail description given herein below and the accompanying drawings which are given by way of illustration only, wherein like reference numerals designate corresponding parts in the various drawings, and wherein:

FIG. 1 illustrates a general architecture of a well-known wireless communication network.

FIG. 2 illustrates a portion of the BTS and RNC of FIG. 1 modified according to an embodiment of the present invention to implement method embodiments of the present invention.

FIG. 3 illustrates a communication flow diagram for setting up the packet data session flow between an AT and a RNC.

FIG. 4 illustrates an embodiment of determining the reverse link identifier.

FIG. 5 illustrates an embodiment of the method for determining the forward link context identifier.

FIG. 6 illustrates another communication flow diagram for setting up the packet data session flow between an AT and a RNC.

FIG. 7 illustrates a method of packet data processing at a BTS according to one embodiment.

FIG. 8 illustrates a method of processing the packet data received from a BTS at a RNC according to an embodiment.

### DETAILED DESCRIPTION OF EXAMPLE EMBODIMENTS

Example embodiments will now be described more fully with reference to the accompanying drawings. However, example embodiments may be embodied in many different forms and should not be construed as being limited to the example embodiments set forth herein. Example embodiments are provided so that this disclosure will be thorough, and will fully convey the scope to those who are skilled in the art. In some example embodiments, well-known processes, well-known device structures, and well-known technologies are not described in detail to avoid the unclear interpretation of the example embodiments. Throughout the specification, like reference numerals in the drawings denote like elements.

It will be understood that when an element or layer is referred to as being “on”, “connected to” or “coupled to” another element or layer, it may be directly on, connected or coupled to the other element or layer, or intervening elements or layers may be present. In contrast, when an element is referred to as being “directly on,” “directly connected to” or “directly coupled to” another element or layer, there may be no intervening elements or layers present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Thus, a first element, component, region, layer or section discussed below could be termed a second element, component, region, layer or section without departing from the teachings of the example embodiments.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting. As used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

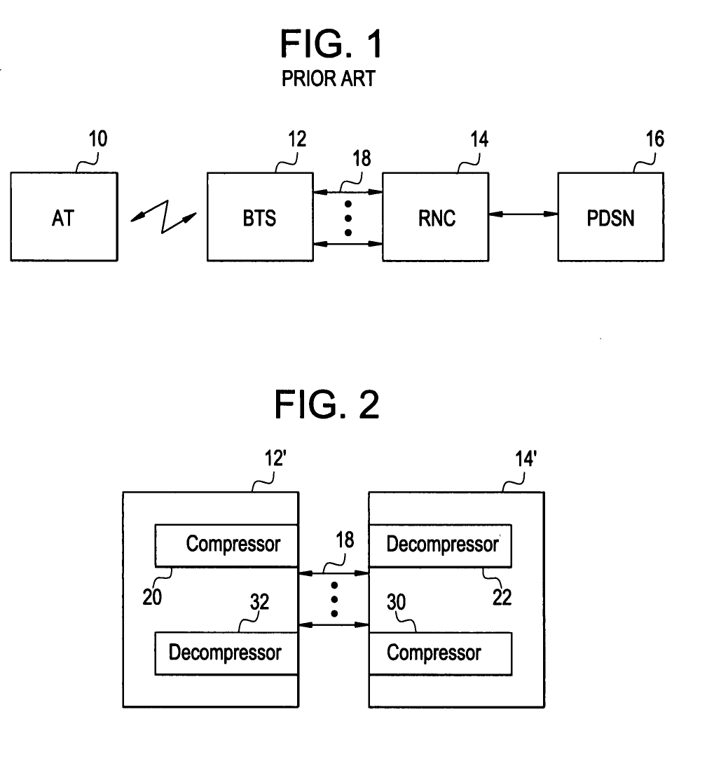

FIG. 2 illustrates a portion of the BTS and RNC of FIG. 1 modified according to an embodiment of the present invention to implement method embodiments of the present invention. As shown, the interface 18 connects a BTS 12′ and the RNC 14′. The interface is often called the backhaul. In particular, the interface 18 typically includes multiple T1/E1 lines connected between the BTS 12′ and the RNC 14′ for carrying packet data (e.g., IP packet data) between the BTS 12′ and the RNC 14′. Packet data flowing from the BTS 12′ to the RNC 14′ is said to flow over the reverse link, and packet data flowing from the RNC 14′ to the BTS 12′ is said to flow over the forward link. Typically, the transmission of packet data between the BTS 12′ and the RNC 14′ follows a BTS/RNC transmission protocol such as the well-known Remote Method Invocation (RMI) protocol. For ease of explanation only, the embodiments of the present invention will be described as implementing the RMI protocol as the BTS/RNC protocol. However, it will be understood that the present invention is not limited in its application to the RMI protocol.

The BTS 12′ is the same as the BTS 12 of FIG. 1, except that the BTS 12′ has been programmed to implement the methodologies of the present invention. For example, as shown by logical block diagram in FIG. 2, the BTS 12′ includes a compressor 20 and decompressor 22. Similarly, the RNC 14′ is the same as the RNC 14 of FIG. 1, except that the RNC 14′ has been programmed to implement the methodologies of the present invention. For example, as shown by logical block diagram in FIG. 2, the RNC 14′ includes a decompressor 22 and a compressor 30. The compressor 20 selectively compresses at least a portion of the RMI protocol header on reverse link packet data. The decompressor 22 decompresses RMI protocol headers compressed by the compressor 20. The compressor 30 selectively compresses at least a portion of the RMI protocol header on forward link packet data. The decompressor 32 decompresses RMI protocol headers compressed by the compressor 30.

The conventional RMI header is 44 bytes long. The first 2 bytes conventionally contain the length field that indicates the total length of the RMI packet. However, many of the fields in the RMI header remain static. According to embodiments of the present invention, the static fields are stored at the BTS 12′ and/or RNC 14′ in association with a respective context identifier for the communication flow. The RMI header may then be compressed at the RNC 14′ or the BTS 12′, and then decompressed at the other of the BTS 12′ or the RNC 14′.

In compressing the RMI header, the RMI header may be compressed or reduced to 7 bytes. The first two bytes provide a compression mode indicator, compression level indicator and the context identifier. The compression mode indicator may be the most significant bit of the RMI header, and indicates whether the header is compressed or not. If the most significant bit is set, for example, to 1, this indicates compression. However, if the most significant bit is not set (e.g., is a 0), then this indicates no header compression, and the first two bytes represent the length of the RMI packet.

The second bit in the first two bytes of the RMI header indicates the compression level. The fields which will remain static during a communication flow may depend on factors regarding the state of the AT 10. For example, mobility is one of the factors regarding the state of the AT 10 that may influence compression. If the AT has moved from one cell to another, and is involved in a hand-off, there will be fewer static fields then if the AT 10 is being served by a single BTS 12′. As a result, there may be at least two different levels of compression desired based on the state of AT. In particular, when the AT 10 is not involved in a hand-off, the RMI header may be compressed down to 7 bytes. However, if the AT is involved in a hand-off, than the RMI header is compressed down to 9 bytes. Furthermore, instead of implementing this lesser compression on both the forward link and the reverse link, the lesser compression may be implemented on only one of the forward link and the reverse link. As briefly mentioned above, to indicate the level of compression, the second bit of the RMI header is used. In particular, if this second bit is not set, then full compression is indicated, and the RMI header will be compressed to the 7 byte header. However, if the second bit of the RMI header is set, then the RMI header will be compressed down to the 9 bytes. As will be appreciated, the context identifier of the forward link and reverse link may be reduced to less than 14 bits such that the compression level indicator may be increased to greater than 1 bit; and thus, indicate different levels of compression. It will further be appreciated, that the levels of compression may be predetermined and stored at the BTS 12′ and the RNC 14′ such that each of the BTS 12′ and RNC 14′ knows, a priori, the level of RMI header compression to perform based on the compression level indicator.

The remaining 14 bits in the first two bytes of the RMI header provide the context identifier. As will be described in detail below, the context identifier for a communication flow depends on whether the flow is over the forward link or reverse link. Namely, the reverse link context identifier identifies the communication flow over the reverse link and the forward link context identifier identifies the communication flow over the forward link. In decompressing the RMI header, the context identifier in the compressed RMI header is used to access the stored static fields for the communication flow, and these fields are used to reconstruct the full RMI header.

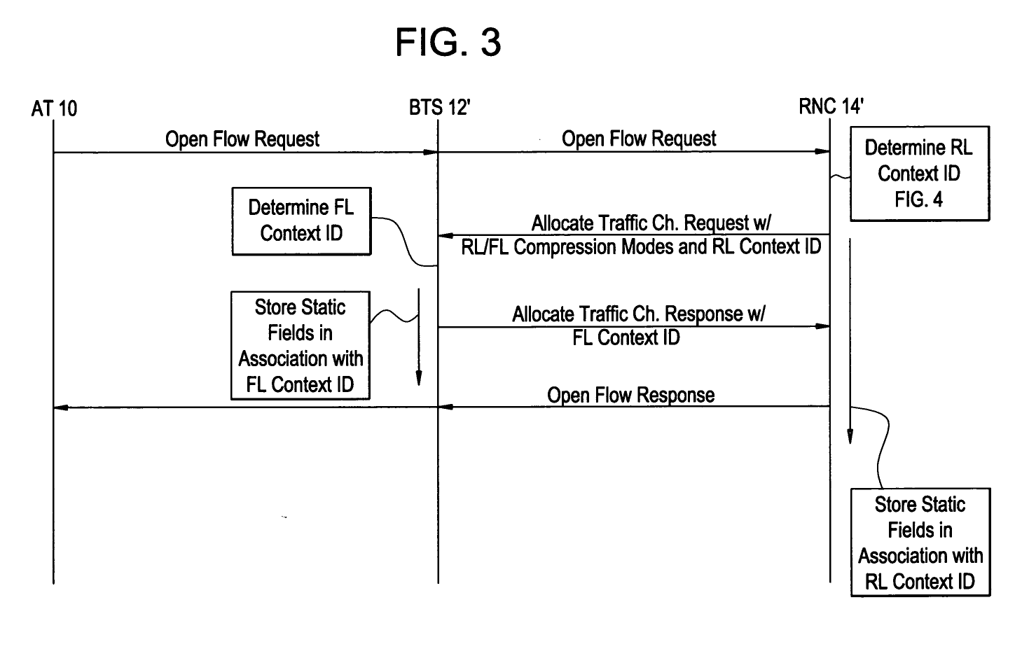

Next operation of the BTS 12′ and RNC 14′ will be described in detail below with respect to FIGS. 3-8.

FIG. 3 illustrates a communication flow diagram for setting up the packet data session flow between the AT 10 and the RNC 14′. In particular, FIG. 3 illustrates the AT 10 originating the establishment of the data packet flow. As shown, the AT 10 sends an open flow request message to the BTS 12′. The BTS 12′ forwards the open flow request to the RNC 14′. In response to receiving the open flow request, the RNC 14′ determines whether to grant the flow request and allocate the appropriate resources. This is done in the conventional or any well-known manner. Assuming the RNC 14′ grants the flow request and allocates the appropriate resources, the RNC 14′ also determines the reverse link (RL) contact identifier (ID). It should be noted that a single AT 10 may have more than one flow. For example, the AT 10 may have a VOIP flow for voice communication and have a best efforts (BE) flow for internet browsing.

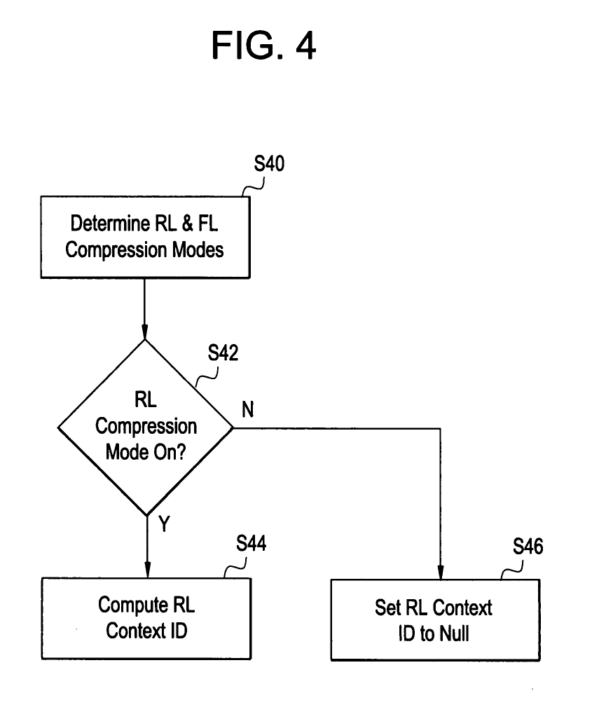

FIG. 4 illustrates an embodiment of determining the reverse link identifier. As shown, in step S40, the RNC 14′ determines whether to turn on compression of the RMI header in the forward and reverse links. Stated another way, the RNC 14′ sets the forward link compression mode to either on or off, and set the reverse link compression mode to either on or off. As discussed previously, the small packet volume such as with VOIP and PTT applications causes transport inefficiency. Accordingly, the RNC 14′ determines the type of flow (e.g., VOIP, PTT, BE, etc.) from well-known information in the open flow request. The RNC 14′ compares this information to a database that indicates whether to implement compression on the forward link and whether to implement compression on the reverse link for the identified type of flow. It will be appreciated, that some flow types may have compression turned on in the reverse link and not in the forward link, and vice versa. The database indicating compression based on flow type may be programmed considering the expected packet size over each link for each flow type. For example, the expected packet size on the forward link for a BE flow may be quite large (e.g., up to 1500 bytes), and therefore, the forward link compression mode is set to off for a BE flow. However, the expected packet size on the reverse link for a BE flow may be quite small (e.g., around 16 bytes), and therefore, the reverse link compression mode is set to on for a BE flow.

Next in step S42, if the reverse link compression mode has been set to on, processing proceeds to step S44. In step S44, the RNC 14′ computes the reverse link context identifier based on the session identifier. As is well-known, each active flow has a session at the RNC 14′. Namely, information particular to the flow such as the protocol negation at the various layer, etc. is stored at the RNC and referred to as a session. Furthermore, an identifier is assigned to the session and referred to as the session identifier. The reverse link context identifier may be the same as, a portion of, or include a portion of the session identifier. Alternatively, the reverse link context identifier may be a permutation of the session identifier or derived based on a function using the session identifier.

If in step S42 the reverse link compression mode is not on, then in step S46 the RNC 14′ sets the reverse link context ID to null.

Returning to FIG. 3, the RNC 14′ sends an allocate traffic channel request to the BTS 12′ along with an indication of the forward link and reverse link compression modes and the reverse link context identifier. The RNC 14′ may begin storing the static fields of the RMI header in association with the reverse link context identifier.

In response to the allocate traffic channel request, the BTS 12′ allocates resources in the conventional or any well-known manner. The BTS 12′ also determines the forward link (FL) context identifier.

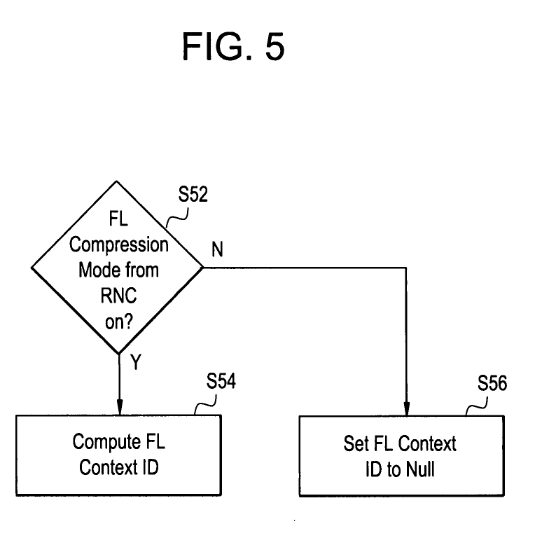

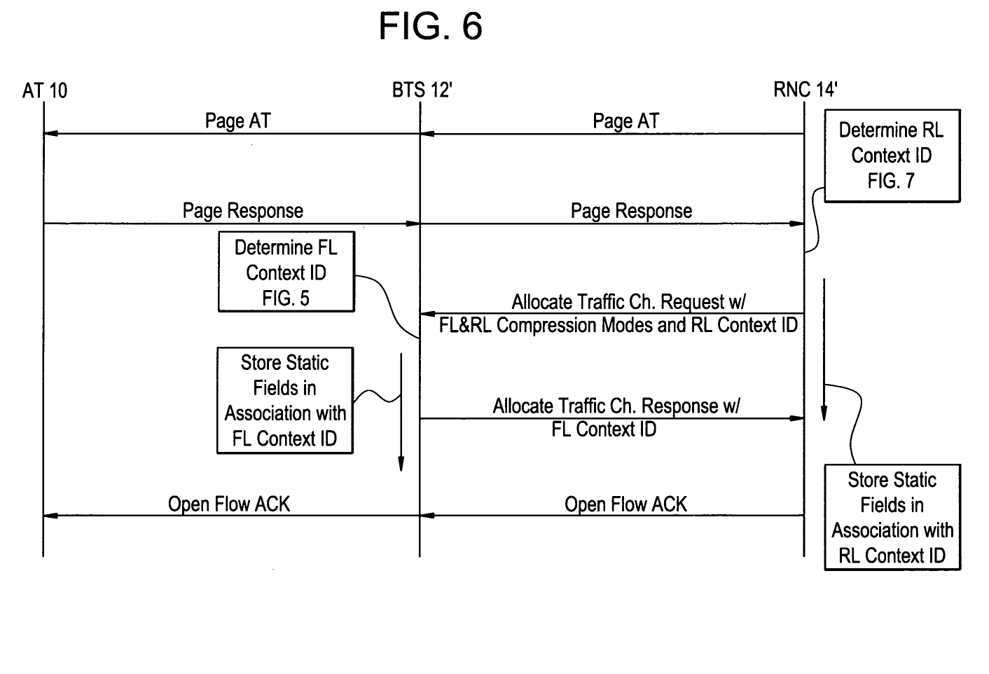

FIG. 5 illustrates an embodiment of the method for determining the forward link context identifier. As shown, in step S52, the BTS 12′ determines whether the forward link compression mode received from the RNC 14′ is set to on. If so, then in step S54, the BTS 12′ computes the forward link context identifier. The forward link context identifier is computed based on two fields: the flow identifier and the traffic channel element identifier. As discussed above, a single user may have multiple flows open; for example, a VOIP flow for voice communication and a BE flow for internet browsing. As is well-known, all the flows from a single user are assigned to a single traffic channel element. The traffic channel element prepares and processes the air interface messages for transmitting and receiving a stream of information packets over the air interface to/from the AT 10. As is well-known, the traffic channel element identifier identifies this traffic channel element. As is further well-known, to distinguish between the different flows from a single user, each flow is assigned an identifier called the flow identifier.

As discussed above, the context identifier, whether forward link or reverse link, is 14 bits long. In the forward link, the most significant 4 to 6 bits may be used as the flow identifier. For example, if 4 bits are used as the flow identifier, then 16 flows per AT are supported. The remaining 8 to 10 bits are the same as the 8 to 10 least significant bits as the traffic channel element ID.

Returning to step S52, if the forward link compression mode from the RNC 14′ is not indicated as being on, then in step S56 the forward link context is set to null.

Returning to FIG. 3, after determining the forward link context ID, the BTS 12′ sends an allocate traffic channel response to the RNC 14′ along with the forward link context ID. The BTS 12′ may also begin storing the static fields of the RMI header in association with the forward link context identifier. During the above-described communication flow of FIG. 3, the RNC 14′ and the BTS 12′ record the static fields of the RMI header. Namely, it is known by both the RNC 14′ and the BTS 12′ which fields of the RMI header remain unchanged during traffic data communication. As a result, in preparation for possible compression, the RNC 14′ and the BTS 12′ store these static fields.

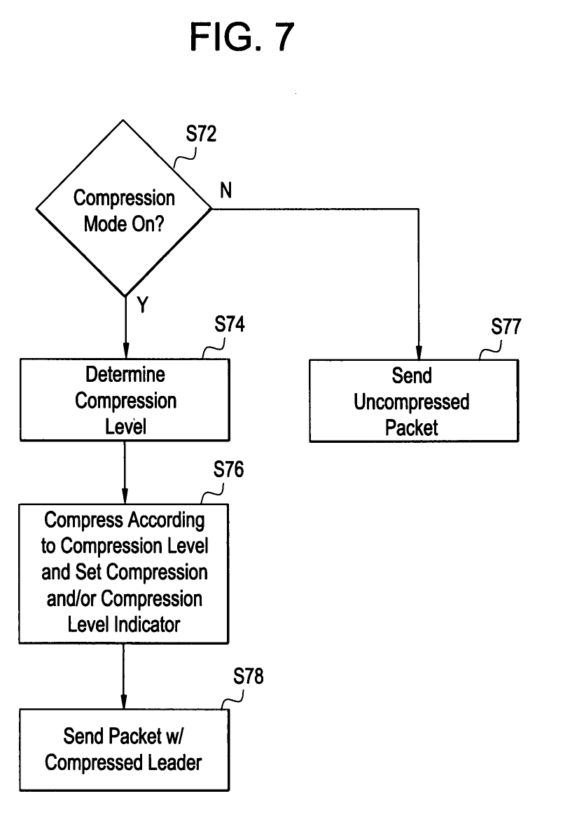

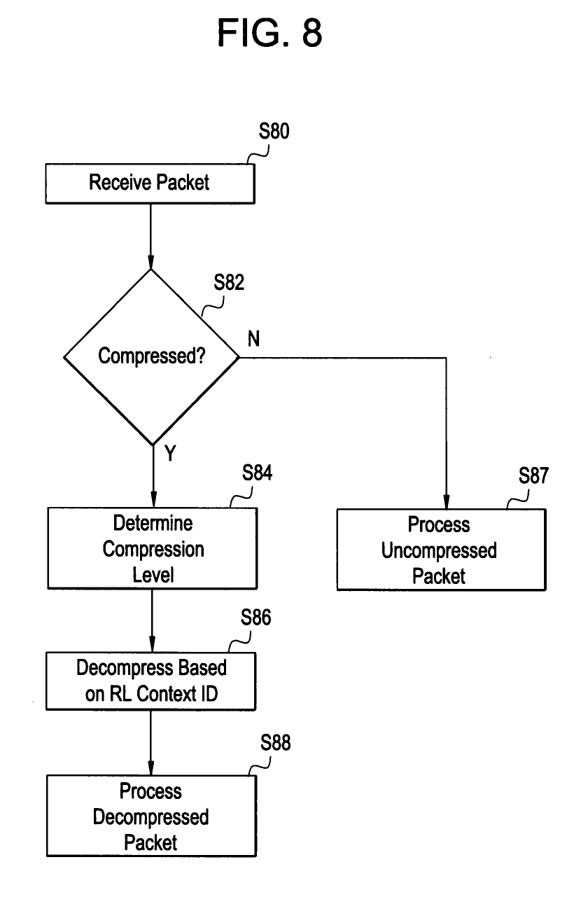

Having received the allocate traffic channel response, the RNC 14′ sends an open flow response to the AT 10, which is transferred to the AT 10 by the BTS 12′. At this point, communication flow takes place, and will be described in further detail below with respect to FIGS. 7-8.

FIG. 3 illustrates opening a communication flow between the AT 10 and the RNC 14′ based on origination by the AT 10. However, it will be appreciated that communication flow between the AT 10 and RNC 14′ may be initiated on the network side. This is illustrated in FIG. 6. As shown in FIG. 6, if communication with the AT 10 is requested and that request is received by the RNC 14′, the RNC 14′ sends a page to the AT 10 via the BTS 12′. If the AT 10 receives the page, the AT 10 sends a page response to the RNC 14′ via the BTS 12′. Then the communication flow is the same as described above with respect to FIG. 3 with RNC 14′ determining the reverse link context ID and sending the allocate traffic channel request with the forward and reverse link compression modes and the reverse link context ID. The BTS 12′ performs the same as in FIG. 3, which includes determining the forward link context ID and sending the allocate traffic channel response with the forward link context identifier to the RNC 14′. In response to receiving the allocate traffic channel response, the RNC 14′ sends an open flow acknowledgement to the AT 10 via the BTS 12′, and the communication flow begins.

Next, processing of the packet data on the reverse link will be described. As will be appreciated, the AT 10 sends packet data to the BTS 12′. The BTS 12′ then processes the packet data based on the reverse link compression mode and/or the compression level. FIG. 7 illustrates a method of packet data processing at the BTS 12′ according to one embodiment. As shown, in step S72, the BTS 12′ determines whether or not the compression mode is on. As will be recalled, in the communication flow of FIG. 3 or FIG. 6, the RNC 14′ determined the setting for the reverse link compression mode and communicated that to the BTS 12′. If the reverse link compression mode is on, then in step S74, the BTS 12′ determines the compression level based on the operating state of the AT 10. In this example, the operating states are assumed to include a hand-off state and a non-hand-off state.

Next, in step S76, the BTS 12′ employs the compressor 20 to compress the RMI header in accordance with the compression level. For example, if the AT 10 is not involved in a hand-off, then the RMI header may be compressed down to 7 bytes. The last 5 bytes are the non-static fields of the conventional RMI header. The first 2 bytes consist of the compression indicator, the compression level indicator and the reverse link context ID. In particular, the first bit of the RMI header serves as the compression indicator, and is selectively set to indicate that compression has occurred. At least the second bit of the RMI header serves as the compression level indicator, and is selectively set to indicate full compression (no hand-off) or partial compression (hand-off). The reverse link context ID received from the RNC 14′ and stored at the BTS 12′ fills out the remaining bits. Then, in step S76 the packet is sent with the compressed header. It will be appreciated that conventionally, the length indicator of an uncompressed RMI header does not have the most significant bit set as a “1”; and hence, is easily used as the compression indicator. However, it will also be appreciated that other bit positions in the RMI header could be used for not only the compression indicator, but also the compression level indicator and the context identifier.

Returning to step S72, if the reverse link compression mode is not on, then in step S77, the BTS 12′ sends the packet data with an uncompressed RMI header in the conventional manner.

FIG. 8 illustrates a method of processing the packet data received from the BTS 12′ at the RNC 14′ according to an embodiment.

As shown, in step S80 a packet is received. Then, in step S82 the RNC 14′ determines whether or not the RMI header has been compressed. In particular, the RNC 14′ determines from the first bit of the RMI header whether or not the RMI header has been compressed. If the first bit is set, than the RNC 14′ determines that the RMI header has been compressed. If the first bit of the RMI header is not set, then the RNC 14′ determines that the RMI header has not been compressed.

Assuming the RMI header has been compressed, then in step S84, the RNC 14′ determines the compression level. The compression level is indicated by the second bit in the RMI header. In accordance with the example of FIG. 7, two operating states for the AT 10 have been assumed in describing the embodiments of the present invention. Those two states include the AT 10 being involved in a hand-off and the AT 10 not being involved in a hand-off. If the AT 10 is involved in a hand-off, then the second bit of the RMI header is set, while if the AT 10 is not involved in a hand-off the second bit of the RMI header is not set. However, it will be appreciated that the lesser compression mode may not be used on the reverse link. For example, in one embodiment, full compression is used on the reverse link regardless of whether the AT 10 is involved in a hand-off; while lesser compression is used on the forward link when the AT 10 is involved in a hand-off, and full compression is used on the forward link when the AT 10 is not involved in a hand-off.

In step S86, the decompressor 22 of the RNC 14′ decompresses the RMI header in accordance with the determined compression level. Namely, the decompressor 22 uses the reverse link context identifier to identify the communication flow and access the stored static fields. A full RMI header is constructed using the accessed static fields. For example, if the AT 10 is not involved in a hand-off, then to the 7 byte compressed RMI header, the decompressor 22 adds the other 37 static bytes. However, if the AT 10 is involved in a hand-off and the lesser compression is used, then to the 9 byte compressed RMI header, the decompressor 22 adds the static bytes. The RNC 14′ then processes the decompressed packet in the conventional manner in step S88.

If in step S82 the RMI header is not compressed, then in step S87, the RNC 14′ processes the uncompressed packet in the conventional manner.

The forward link data packet processing is the same as discussed above with respect to FIGS. 7 and 8 except that compression is performed by compressor 30 at the RNC 14′ and decompression is performed by the decompressor 32 at the BTS 12′. Furthermore, compression is based on the forward link compression mode, and instead of inserting a reverse link context identifier, the compressor 30 inserts the forward link context identifier in step S76. And, instead of using the reverse link context identifier to access the stored static fields in step S86, the forward link context identifier is used.

As will be appreciated in the above discussion, by compressing the conventional 44 byte RMI header down to 7 bytes, or in some cases 9 bytes, the transport efficiency between the BTS and RNC is significantly improved.

The invention being thus described, it will be obvious that the same may be varied in many ways. For example, while embodiments of the present invention were described with respect to an EVDO system, it will be appreciated that the present invention is not limited to this system. Such variations are not to be regarded as a departure from the invention, and all such modifications are intended to be included within the scope of the invention.

We claim:

1. A method of managing header compression, comprising:
determining, at a first network element, whether to turn on compression of a header for a packet transport protocol used for a communication flow between the first network element and a second network element, the determining being based on a type of the communication flow, the packet transport protocol being a protocol for transport of packets between the first and second network elements; and
sending a compression mode indictor to the second network element along with a context identifier, the compression mode indicator indicating the determination, the context identifier for use in identifying the communication flow.

2. The method of claim 1, wherein
the determining step determines whether to turn on compression for the reverse link based on the type of communication flow and whether to turn on compression for the forward link based on the type of communication flow, the reverse link being from the second network element to the first network element and the forward link being from the first network element to the second network element; and
the sending step sends a forward link compression mode indicator and reverse link compression mode indicator, the forward link compression mode indicator indicating whether the determining step determined to turn on compression for the forward link, and the reverse link compression mode indicator indicating whether the determining step determined to turn on compression for the reverse link.

3. The method of claim 2, wherein the sending step sends a reverse link context identifier for use in identifying the communication flow on the reverse link.

4. The method of claim 3, further comprising:
determining the reverse link context identifier based on a session identifier for the communication flow if the determining step determines to turn on compression for the reverse link, the session identifier for distinguishing the communication flow from other communication flows.

5. The method of claim 4, further comprising:
setting the reverse link context identifier to a fixed number if the determining step determines not to turn on compression for the reverse link.

6. The method of claim 3, further comprising:
receiving a forward link context identifier from the second network element, the forward link context identifier for use in identifying the communication flow on the forward link.

7. The method of claim 1, wherein the first network element is a radio network controller, the second network element is a base transceiver station, and the packet transport protocol is Remote Method Invocation protocol.

8. A method of managing header compression, comprising:
receiving, from a first network element, at least a forward link compression mode indictor and a reverse link context identifier at a second network element, the forward link compression mode indicator indicating whether compression of a header for a packet transport protocol has been turned on for packets of a communication flow over a forward link, the packet transport protocol being a protocol for transport of packet between the first and second network elements, the reverse link being communication flowing from the second network element to the first network element, the reverse link context identifier for use in identifying the communication flow on the reverse link, the forward link being communication flowing from the first network element to the second network element;
determining a forward link context identifier based on the forward link compression mode indicator, the forward link context identifier for use in identifying the communication flow on the forward link; and
sending the forward link context identifier to the first network element.

9. The method of claim 8, wherein the determining step determines the forward link context identifier based on a traffic channel element identifier if the forward link compression mode indicator indicates compression has been turned on.

10. The method of claim 9, wherein the determining step sets that first four to six most significant bits of the forward link context identifier as a flow indicator and sets the remaining number of bits of the forward link context identifier equal to the last significant remaining number of bits of the channel elements identifier, the flow indicator for distinguishing the communication flow from other communication flows from a same user.

11. The method of claim 9, wherein the determining step sets the forward link context identifier to a fixed value if the forward link compression mode indicator indicates compression has not been turned on.

12. The method of claim 8, wherein the first network element is a radio network controller, the second network element is a base transceiver station, and the packet transport protocol is Remote Method Invocation protocol.

13. The method of claim 8, wherein the receiving step further receives a reverse link compression mode indicator indicating whether compression of the header for the packet transport protocol has been turned on for packets of the communication flow over the reverse link

14. A method of processing a packet data flow, comprising:
determining whether compression of a header for a packet transport protocol between a first network element and a second network element has been turned on for a communication flow between the first network element and the second network element; and
generating a compressed header that includes a context identifier if the determining step determines that compression has been turned on, the context identifier for use in identifying the communication flow.

15. The method of claim 14, wherein the context identifier is one a first direction and a second direct context identifier, the first direct context identifier for identifying the communication flow from the first network element to the second network element and the second direction context identifier for identifying the communication flow from the second network element to the first network element.

16. The method of claim 14, wherein the generating step selectively sets a prescribed bit of the compressed header to indicate whether the header is compressed.

17. The method of claim 14, further comprising:
determining a compression level for the compression if the determining step determines that compression has been turned on; and wherein
the generating step generates the compressed header to indicate the determined compression level.

18. The method of claim 17, wherein the determining a compression level step determines the compression level based on a state of an end user associated with the communication flow.

19. The method of claim 18, wherein the determining a compression level step determines a lower level of compression if the end user is in a handoff than if the end user is not in a handoff.

20. The method of claim 17, wherein the generating step selectively sets a prescribed bit of the compressed header to indicate whether the header is compressed, and selectively sets at least another prescribed bit to indicate the determined compression level.

21. The method of claim 17, wherein the determining a compression level step determines the compression level based on a direction of the communication flow, the direction being one of from the first network element to the second network element and from the second network element to the first network element.

22. A method of processing a packet data flow, comprising:
receiving a packet according to a transport protocol for packet communication between a first network element and a second network element;
determining whether a header of the packet has been compressed;
decompressing the header based on a context identifier in the compressed header if the determining step determines the header has been compressed, the context identifier identifying a communication flow between the first network element and the second network element.

23. The method of claim 22, wherein the context identifier is one a first direction and a second direct context identifier, the first direct context identifier for identifying the communication flow from the first network element to the second network element and the second direction context identifier for identifying the communication flow from the second network element to the first network element.

24. The method of claim 22, wherein the determining step determines whether the header has been compressed based on a state of a prescribed bit of the header.

25. The method of claim 22, further comprising:
determining a compression level for the compression if the determining step determines that compression has been turned on; and wherein
the decompressing step decompresses the header based on the determined compression level.

26. The method of claim 25, wherein the determining a compression level step determines the compression level based on a state of a prescribed bit of the header.
